(19) United States
(12) Patent Application Publication
(10) Pub. No.: US 2023/0060366 A1
(43) Pub. Date: Mar. 2, 2023

(54) BREAD CUTTING MACHINE WITH CUTTING PROCESS AID, AND OPERATING METHOD

(71) Applicant: Bizerba SE & Co. KG, Balingen (DE)

(72) Inventor: Leo Korell, Balingen (DE)

(21) Appl. No.: 17/781,380

(22) PCT Filed: Nov. 9, 2020
(86) PCT No.: PCT/EP2020/081422

§ 371 Date: Jun. 1, 2022

(30) Foreign Application Priority Data
Dec. 5, 2019 (EP) 19213899.8

(51) Int. Cl. B26D 1/16; B26D 7/02; B26D 7/32

(52) U.S. Cl. CPC B26D 1/16; B26D 7/02; B26D 7/32; B26D 2007/011

(57) ABSTRACT

A bread slicer includes an controller configured to cause claws to reach into an end-face securing portion, which is elongated in the direction of a connecting axis, of a loaf introduced into a feed chute, cause the loaf to be transported into a receiving chute over a blade gap, and cause a slicing blade to travel into the blade gap multiple times automatically during the transportation in order to cut off one slice from the loaf each time, and the slicing blade then moving fully back out of the blade gap again in order to allow each cut-off slice to be transported onward into the receiving chute and to allow the rest of the unsliced loaf to be transported onward over the blade gap. The receiving chute is above the feed chute. The connecting axis between the feed and receiving chute is vertically inclined by at least 30°.

### CROSS REFERENCE TO RELATED APPLICATIONS

This application is a U.S. National Phase application under 35 U.S.C. § 371 of International Application No. PCT/EP2020/081422, filed on Nov. 9, 2020, and claims benefit to German Patent Application No. EP 19213899.8, filed on Dec. 5, 2019. The International Application was published in German on Jun. 10, 2021 as WO 2021/110361 A1 under PCT Article 21(2).

### FIELD

The present invention relates to a bread slicer for cutting a loaf of bread into slices.

### BACKGROUND

DE 20 2008 003 603 U1 (=reference [0]) and DE 44 31 808 C2 (=reference [1]) disclose bread slicers.

Bread slicers may have a gripper for displacing the loaf and a counter-support opposite the gripper on the loaf, which counter-support holds the bread slices of the sliced loaf in position. In this case, the counter-support has to be moved in sync with the gripper. Generally, the gripper is located in a loading region in which the user loads the loaf. The gripper therefore always has to be removed from the loading region first before the loaf is loaded, which is time-consuming.

DE 10 2010 036 721 B4 (=reference [2]) describes a bread slicer in which a loaf is advanced by means of an advancing device onto a slicing apparatus of the bread slicer and is sliced into a pack of slices. The pack of slices is pushed from the slicing region through an opening in a wall of the slicer housing of the bread slicer onto a holding device, generally automatically.

EP 3 102 376 B1 (=reference [3]) discloses a bread slicer, the chute of which has two chute regions separated by a slot. A circular blade travels through the slot and, in doing so, cuts bread at the slot, thereby producing bread slices below the slot. An offset is formed between the chute regions, which offset can be made smaller by moving the chute regions relative to one another.

EP 3 331 674 B1 (=reference [4]) describes a bread slicer having a first chamber for inserting bread, a second chamber for receiving the bread, and a blade for cutting the bread between the chambers. The first chamber is arranged above the second chamber. A supporting surface supports the bread in the first chamber. A movable slide in the first chamber conveys the bread toward the second chamber, the bread being displaced substantially vertically. The slide has hook-in means for holding the bread counter to the force of gravity. A detector detects the proximity of the bread to the slide, upon which the hook-in means can then be extended. After being sliced, the bread is conveyed back into the first chamber.

One drawback is that this bread slicer requires a support for supporting the cut-off bread slices, so it is relatively complicated. Once the bread has been conveyed back into the first chamber, the slide is removed, in a time-consuming manner, in order to be able to remove the bread from the first chamber.

Reference [1] discloses a slicer in which a loaf of a foodstuff (generally a loaf of bread) in an unsliced state is guided past a cutting disk from the top downward in a chute that is inclined slightly with respect to the vertical. In the process, the length of the foodstuff loaf is ascertained. The loaf is then conveyed from the bottom upward in the chute and cut into slices by the cutting disk in the process. Once again, this configuration of a bread slicer is also structurally complex, having both a closure plate and a holding plate between which a loaf to be sliced is arranged.

In this case too, a holding plate is thus required, in an unfavorable manner, in order to hold the loaf, which has been sliced either fully or partly, in its (almost vertical) position. Before a loaf is removed from the chute, and after a new loaf is loaded, the holding plate has to be moved back into its starting position, in a time-consuming manner, in order to leave room for the loaf.

Reference [0] discloses a bread slicer, in which the receiving chute is arranged below the feed chute in the vertical direction. When viewed in the conveying direction, the end position of the transportation slide is located upstream of the slot into which the circular blade can be inserted. The transportation slide as per reference [0] is therefore not configured to be moved over the slot. In addition, while reference [0] does mention claws on the transportation slide, which are intended to stick into the end of the length of food sufficiently firmly, it does not mention any defined movement actuation thereof. Moreover, reference [0] does not disclose any control that causes the unsliced loaf loaded into the receiving chute to be transported into the transportation chute.

### SUMMARY

In an embodiment, the present disclosure provides a bread slicer that cuts a loaf of bread into slices. The bread slicer has: a slicer housing, the slicer housing accommodating a drive motor and a slicing blade, the slicing blade being configured to be driven by the drive motor, the slicing blade being retained on a blade arm, and the slicing blade being configured to rotate in a slicing plane or to be movable in a circulating manner; a feed chute configured to introduce the loaf to be sliced into the bread slicer; a receiving chute, which adjoins the feed chute except for a blade gap, the receiving chute being configured for receiving all of the slices of the sliced loaf; and an advancing plate, the advancing plate being configured such that an end face of the loaf introduced into the feed chute rests thereon and comprising a gripper provided with claws for holding the loaf. A connecting axis between the feed chute and the receiving chute is arranged in a manner inclined with respect to a vertical by at least 30°. The receiving chute is arranged above the feed chute in a vertical direction. The advancing plate is configured such that it is able to travel from one end of the feed chute remote from the receiving chute as far as over the blade gap and back again. The bread slicer further includes an electronic controller, which is configured to: cause the claws of the gripper to extend out and reach into an end-face securing portion, which is elongated in the direction of the connecting axis, of the loaf introduced into the feed chute, then to cause the as-yet-unsliced loaf to be transported into the receiving chute over the blade gap, and to cause the slicing blade to travel into the blade gap multiple times automatically during the transportation in order to cut off one slice from the loaf each time, and the slicing blade then moving fully back out of the blade gap again in order to allow each cut-off slice to be transported onward into the receiving chute and to allow the rest of the as-yet-unsliced loaf to be transported onward over the blade gap.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic vertical section through a bread slicer according to an aspect of the invention, with the cover open;

FIG. 2 is a section through the bread slicer according to FIG. 1, with a loaded loaf and the cover closed;

FIG. 3 is a section through the bread slicer according to FIG. 2, with the loaf resting on the slicing blade;

FIG. 4 is a section through the bread slicer according to FIG. 3, with the loaf resting on the advancing plate;

FIG. 5a is a section through the bread slicer according to FIG. 4, with the loaf sliced approximately halfway;

FIG. 5b is a section through the bread slicer according to FIG. 5a, with the loaf sliced except for one remaining portion;

FIG. 6 is a three-dimensional schematic view of a feed chute, a receiving chute, a slicing blade, and a crumb compartment of the bread slicer according to an aspect of the invention;

FIG. 7 is a schematic sectional view from above of an embodiment of the bread slicer according to the invention;

FIG. 8 shows a possible movement path of the slicing blade;

FIG. 9a is a three-dimensional schematic view of the feed chute, the receiving chute, and the advancing plate comprising a gripper equipped with teeth;

FIG. 9b is a three-dimensional schematic view of the feed chute and the receiving chute according to FIG. 9a, with the slicing blade having been inserted into the blade gap; and

FIG. 10 is a flowchart for schematically illustrating the bread slicing method according to an aspect of the invention.

### DETAILED DESCRIPTION

The present disclosure relates to a bread slicer for cutting a loaf of bread into slices, comprising a slicer housing, which accommodates a drive motor and a slicing blade, which is driven by said drive motor, retained on a blade arm and rotates in a slicing plane and/or is movable in a circulating manner, comprising a feed chute for introducing the loaf to be sliced into the bread slicer, comprising a receiving chute, which adjoins the feed chute except for a blade gap, for receiving all the slices of the sliced loaf, and comprising an advancing plate, on which the loaf introduced into the feed chute rests by its end face and which has a gripper provided with claws for holding the loaf, the connecting axis between the feed chute and the receiving chute being arranged in a manner inclined with respect to the vertical by at least 30°.

In an embodiment, the present disclosure addresses the problem, which is relatively challenging when considered in detail, of configuring a generic bread slicer having the above-listed feature in a structurally simple and material-efficient way such as to allow a stable slicing process to be carried out in a time-saving manner.

The present invention solves this problem in both a surprisingly simple and effective way in that the receiving chute is arranged above the feed chute in the vertical direction, in that the advancing plate can travel from one end of the feed chute remote from the receiving chute as far as over the blade gap and back again, and in that an electronic control device is present, which is configured to cause the claws of the gripper to extend and reach into an end-face securing portion, which is elongated in the direction of the connecting axis, of a loaf introduced into the feed chute, and then to cause the as-yet-unsliced loaf to be transported into the receiving chute over the blade gap, the control device causing the slicing blade to travel into the blade gap multiple times automatically during the transportation in order to cut off one slice from the loaf each time, and the slicing blade then moving fully back out of the blade gap again in order to allow each cut-off slice to be transported onward into the receiving chute and to allow the rest of the as-yet-unsliced loaf to be transported onward over the blade gap.

In an embodiment, the electronic control device is specifically configured to control transportation of the unsliced loaf from the receiving chute, past the slicing blade, which has been removed from the blade gap, i.e., therefore generally retracted, and into the feed chute, and to then control return transportation of the loaf to be sliced from the feed chute into the receiving chute. During the return transportation, the rotating slicing blade is inserted into and retracted out of the blade gap such that, in the process, the loaf is cut into parallel slices. The loaf is first loaded into the receiving chute, then conveyed into the feed chute, and lastly transported back into the receiving chute, the loaf being cut into slices during its return transportation.

The receiving chute is arranged above the feed chute in the vertical direction. Owing to the at least 30°, in particular approximately 45° but no more than 60°, incline of the connecting axis between the feed chute and the receiving chute with respect to the vertical, the loaf is held in position during the slicing process from the receiving chute into the feed chute and the sliced loaf is prevented from falling over, without—as has been the case up to now—requiring an additional counter-support that is moved by the closure plate and the loaf or otherwise displaced in sync and in parallel with the closure plate. There is thus also no need for the time-consuming moving of the counter-support after the slicing process.

Due to the incline of the connecting axis between the feed chute and the receiving chute, the bread slicer according to the invention additionally has a relatively small footprint compared with known assemblies.

Owing to the electronic control device, the stability of the slicing process can be increased, for example by setting and accordingly controlling a suitable transportation speed of the loaf during the slicing process.

In a preferred embodiment, the electronic control device is also configured to cause the unsliced loaf to be transported from the receiving chute into the feed chute past the retracted slicing blade, which has been removed from the blade gap, and then to cause the loaf that is to be sliced to be transported back from the feed chute into the receiving chute, the slicing blade then being inserted into and retracted out of the blade gap during the return transportation in such a way that the loaf is cut into parallel slices in the process. In particular, the loaf is loaded into the receiving chute, conveyed into the feed chute, and then transported back into the receiving chute, the loaf being sliced during the return transportation.

The bread slicer according to an aspect of the invention is preferably configured such that, in parallel with the slicing plane, the receiving chute is, at its end facing the feed chute, almost as wide as the feed chute in that region. This allows for better support of the loaf at the transition from the feed chute into the receiving chute.

A further embodiment of the bread slicer according to the invention is characterized by a counter-support that can be arranged on the loaf opposite the advancing plate. The counter-support additionally prevents the already-sliced loaf from falling over.

The bread slicer is preferably configured such that a connecting axis between the feed chute and the receiving chute is arranged in a manner inclined with respect to the vertical, preferably by approximately 45°. The oblique orientation prevents the sliced loaf from falling over. The bread slicer can be configured to have a smaller footprint than when the feed chute is oriented horizontally. When the loaf is transported in this manner, there is also no need for a counter-support opposite the advancing plate, said counter-support being intended for preventing the bread from tipping over and being moved by the advancing plate and the bread or otherwise displaced along with the advancing plate in parallel therewith. In general, a counter-support of this kind would need to be removed first when loading the bread.

Further advantages are produced in embodiments of the invention in which the blade arm is configured to move the slicing blade on a curve, preferably a circular curve. This allows the slicing blade to be inserted into the loaf periodically, thereby reducing vibrations in the bread slicer.

Particularly preferred are embodiments of the bread slicer according to the invention that are characterized in that the receiving chute is formed by two sheet metal portions that adjoin each other at an angle and together are L-shaped in cross section. Owing to the L shape, the loaf is supported on two sides. As a result, sufficient support for transporting the loaf is ensured while using little material and adequately controlling the loaf.

One category of advantageous embodiments of the bread slicer according to the invention is characterized in that a cover of the slicer housing is movable in a rotational motion on a guide rail. This allows the opening mechanism for the bread slicer to be configured in a space-saving, compact, and simple manner.

In developments, these embodiments are preferably configured such that the slicing blade, when in a non-activated state outside of the blade gap, is arranged in the bread slicer so as to be impossible to touch from outside of the cover of the slicer housing. This gives users additional protection from the sharp slicing blade.

In particularly preferred developments, the receiving chute is arranged such that, before the slicing process, an unsliced loaf can be placed by a user onto a cantilevered portion, formed as a bagging aid, of the receiving chute, and in that, after the slicing process, the slices of the sliced loaf can be removed from the cantilevered portion by the user, preferably after having pulled a bag-like packaging means thereover. This allows the bread slicer to be configured in a particularly space-saving manner.

Advantageously, the receiving chute, formed as the bagging aid, having the cantilevered portion is arranged inside a cover of the slicer housing such that the bread slicer according to the invention can be formed to be more compact and considerably less bulky in a structurally simple and material-efficient way. In addition, after the slicing process the sliced loaf need not be moved into the region of the bagging aid again by means of a displacement operation. A configuration of this kind also provides increased protection for users from accidental contact with the bread slicer. The bagging aid integrated in the slicer housing thus does not project out from the slicer housing, so while it enlarges the space required by the slicer, there is no longer the risk that a person walking past the slicer gets caught on it. In this construction, the bagging aid is therefore located inside the slicer housing, thereby ensuring a space-saving configuration of the bread machine. Access to the bagging aid from the interior of the bread slicer need not be ensured separately, so structural components for the bread slicer can be omitted. Protection for users of the bread slicer is increased considerably since only one access to the bread slicer has to be made safe. In particular, the bread slicer merely has a single hood for closing a slicing region in which the loaf is sliced.

The external dimensions of the feed chute in directions parallel to the slicing plane should be greater than or equal to the maximum external dimensions in said directions of loaves to be sliced. Additionally, the external dimensions of the cantilevered portion in directions parallel to the slicing plane should, at least at a free end remote from the feed chute, be selected to be smaller than the external dimensions of the feed chute in said directions.

A bread slicer according to an aspect of the invention modified in this manner having the receiving chute has a region of the bread chute into which a user of the bread slicer loads the loaf, the bread chute in particular comprising the receiving chute and also the feed chute. This is also the region from which the user removes the sliced loaf. A support sheet formed as a part of the receiving chute or as the entire receiving chute is thus simultaneously a delivery sheet from which the user can conveniently remove the sliced loaf.

In these embodiments of the invention, the region from which the user can remove the sliced loaf is simultaneously used as the bagging aid. In particular, a bagging aid can be a holding sheet for the loaf that generally does not extend far beyond the loaf in terms of width, or even is narrower than the loaf. This holding sheet is openly accessible on a narrow side, so that the user can pull a packaging means, in particular a bag, over the loaf as long as the loaf is positioned on the bagging aid. The user moves the bag lengthwise along the longitudinal axis of the loaf. In the bread slicer according to an aspect the invention, the delivery sheet is in particular formed as the bagging aid.

Other developments of the above-described preferred category of embodiments are characterized in that the bread slicer has a shorter side and a longer side, the cantilevered portion and an input device for the electronic control device being accessible to a user from the shorter side of the bread slicer. This is particularly advantageous if the bread slicer is intended to be installed in a space-saving manner in the self-service area of a supermarket. In this case, and in particular to save space, the bread slicer is oriented between shelving such that the shorter side of the bread slicer extends in parallel with the direction along the shelving, whereas the longer side of the bread slicer is oriented in the direction of the depth of the shelving. To save space, with the feed chute and receiving chute oriented obliquely, the longer side of the bread slicer can be configured to be shorter than in a bread slicer in which the feed chute and the receiving chute are installed horizontally.

Embodiments of the invention in which through-slots are formed in the feed chute for breadcrumbs to fall through are also particularly preferred. This makes cleaning the feed chute easier. In particular, the breadcrumbs fall through the through-slots and out of the feed chute as early as during the slicing process.

Further, especially advantageous embodiments of the invention are characterized in that a spacing is formed between the advancing plate, in its state maximally retracted away from the receiving chute, and the feed chute. This helps to make cleaning the feed chute simpler.

Developments of these embodiments in which a crumb compartment, in particular having a deflector sheet, is arranged below the advancing plate or the feed chute are also especially preferred. The crumb compartment is used to collect the breadcrumbs produced during the slicing process. In particular, the deflector sheet is oriented so as to point obliquely outward from the edge of the crumb compartment in order to catch as many falling breadcrumbs as possible and guide them into the crumb compartment. Owing to the vibrations that constantly occur during the slicing process, the breadcrumbs primarily fall into the crumb compartment and do not remain in the feed chute or receiving chute.

In this way, the feed chute and receiving chute are, so to speak, cleaned mechanically and automatically during the slicing process itself.

Also advantageous are embodiments of the bread slicer according to the invention in which the extendable claws of the gripper are geometrically configured in terms of shape and extent such that the length of the end-face securing portion of the loaf that has been introduced into the feed chute and is resting on its end face is at most twice the thickness of the slices to be cut off later, and is preferably the same thickness as the slices. This leads to a uniform thickness of the securing portion and of the slices for simple handling of the securing portion during use.

In alternative or additional embodiments of the bread slicer according to the invention, the engagement height of the claws of the gripper, said height corresponding to the length of the end-face securing portion in the direction of the connecting axis, is between 10 mm and 40 mm, preferably from 20 mm to 30 mm. At this length, the securing portion can be handled conveniently during use.

Further advantageous embodiments of the invention are characterized in that a detection apparatus is provided which, in an operating state in which the loaf introduced into the feed chute is moved by means of the advancing plate toward the slicing blade, which has been inserted into the blade gap, can detect when the loaf strikes the slicing blade, the detection apparatus in particular comprising a pressure sensor, preferably attached to the advancing plate, or a photoelectric sensor, or a device for measuring the current electrical current through an electrical drive unit that moves the advancing plate, or a device for measuring the current electrical resistance between the advancing plate and the slicing blade.

The advantage of detecting the loaf at the slicing blade is that no idle passes have to be carried out and the slicing process can begin much more quickly. In particular, an electrical connection is established between the advancing plate and/or the gripper and slicing blade. The loaf establishes the electrical connection as soon as it touches the slicing blade. A current flow from the advancing plate and/or the gripper across the loaf to the slicing blade can then be measured. Alternatively or additionally, the current of a motor that moves the gripper and/or the advancing plate is measured. If the slicing blade creates a mechanical resistance for the loaf, said motor current increases. Alternatively or additionally, a shear force triggered by the loaf can be measured at the bearing of the blade arm by strain gauges or other sensors when the loaf presses against the slicing blade. Alternatively or additionally, a shear force triggered by the loaf can be measured at the gripper and/or the advancing plate by strain gauges or other sensors when the loaf presses against the blade.

A further preferred embodiment of the bread slicer according to the invention is characterized in that the electronic control device is configured to cause the claws of the gripper to extend out of the advancing plate and reach into the securing portion of the as-yet-unsliced loaf in the feed chute only when the detection apparatus detects that the loaf has struck the slicing blade. The loaf is not secured until the slicing process begins. Once the claws of the gripper are inserted, the slicing blade takes on the function of a holding plate such that the loaf is secured between the advancing plate and the slicing blade once the claws are inserted.

A sensor of the bread slicer can be present to switch off the bread slicer, in particular the slicing blade, in an emergency. This contributes to greater safety for users of the bread slicer. The sensor can in particular be arranged on the cover of the bread slicer. Alternatively or additionally, a locking apparatus that keeps the cover of the slicer housing closed during the slicing operation can also be provided.

The bread slicer according to an aspect of the invention is primarily configured for self-service operation by customers in a grocery store or a bakery.

A bread slicing method for cutting off slices from a loaf of bread using a bread slicer according to any of the above-described embodiments is characterized by the following steps:
a) loading the loaf into the receiving chute;
b) moving the advancing plate, with the claws of the gripper retracted, together with the loaf which is resting by its end face on the advancing plate, from a starting position in the receiving chute into an intermediate position at the end of the feed chute remote from the receiving chute;
c) moving the slicing blade into the blade gap;
d) moving the advancing plate out of the intermediate position into a striking position in which the loaf touches the slicing blade;
e) extending the claws of the gripper and inserting them into the loaf, which is secured in the striking position;
f) fully transporting the as-yet-unsliced loaf into the receiving chute over the blade gap in multiple stages, the electronic control device causing the slicing blade to move into the blade gap multiple times automatically during the step-by-step transportation in order to cut off one slice from the loaf each time, and the slicing blade then moving fully out of the blade gap again each time in order to allow each slice to be transported onward into the receiving chute and to allow the rest of the loaf that is still unsliced at this time to be transported onward over the blade gap;
g) retracting the claws of the gripper from the end piece of the otherwise sliced loaf.

In a bread slicing method of this kind, carried out using a bread slicer according to an aspect the invention, the loaf is held in position during the slicing process from the receiving chute into the feed chute, and the sliced loaf is prevented from falling over without the need for an additional holding plate. In step e), once the claws of the gripper are inserted, the slicing blade takes on the function of a holding plate such that the loaf is secured between the advancing plate and the slicing blade once the claws are inserted. Owing to the electronic control device, the stability of the slicing process can be increased, for example by setting a suitable transportation speed of the loaf during the slicing process.

A preferred configuration of the method for operating a bread slicer is characterized in that the aforementioned step e) is carried out only when the detection apparatus has detected that the loaf has struck the slicing blade while step d) is being carried out, and has reported this to the electronic control device. This avoids idle runs and the slicing process can begin much more quickly.

A further particularly preferred configuration of the method for operating a bread slicer is characterized by the following steps:
a) introducing an unsliced loaf into the feed chute, preferably via the receiving chute;
b) cutting the loaf into slices;
c) conveying the slices to the cantilevered portion of the receiving chute;
d) pulling a bag-like packaging means over the bagging aid of the cantilevered portion together with the slices of the sliced loaf that are resting thereon, while the cover of the slicer housing is open;
e) removing the bag-like packaging means, together with the slices of the sliced loaf contained therein, from the cantilevered portion.

In a bread slicing method of this kind, the sliced loaf can be removed in a space-saving and particularly simple manner.

Further advantages of the invention become apparent from the description and the drawings. According to the invention, the aforementioned features and those yet to be stated can likewise each be used either in isolation or together in any combinations. The embodiments shown and described should not be taken to be an exhaustive list, but rather are intended as examples for outlining the invention.

The present invention concerns a bread slicer for cutting a loaf of bread into slices, comprising a bagging aid that is integrated in a space-saving manner.

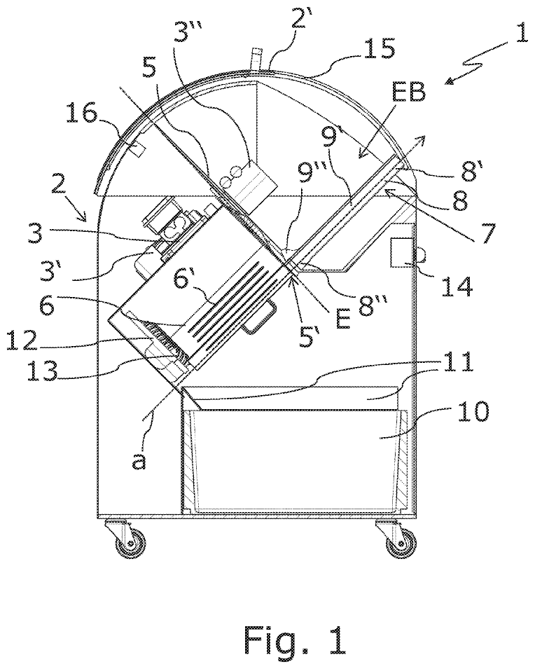

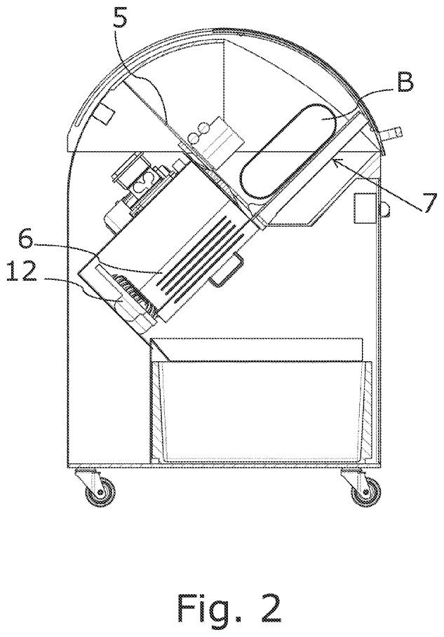

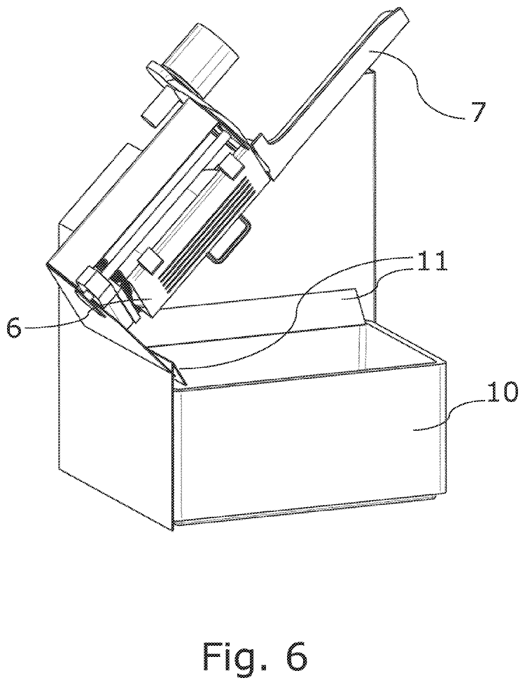

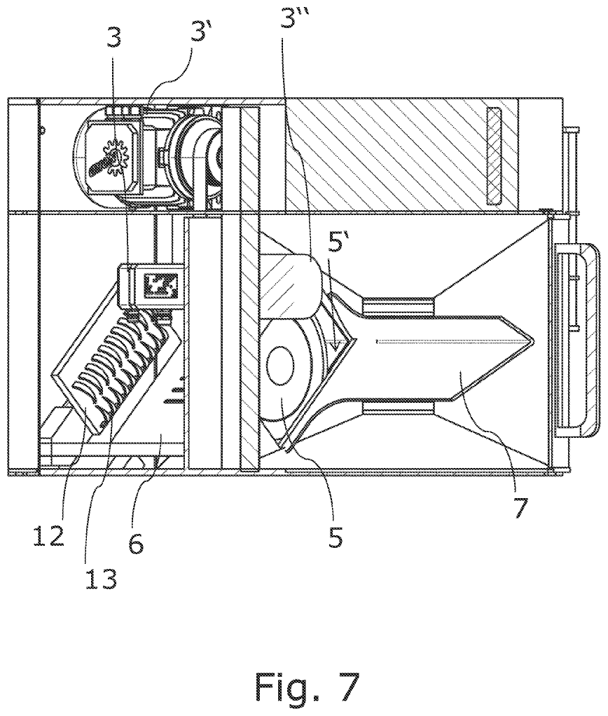

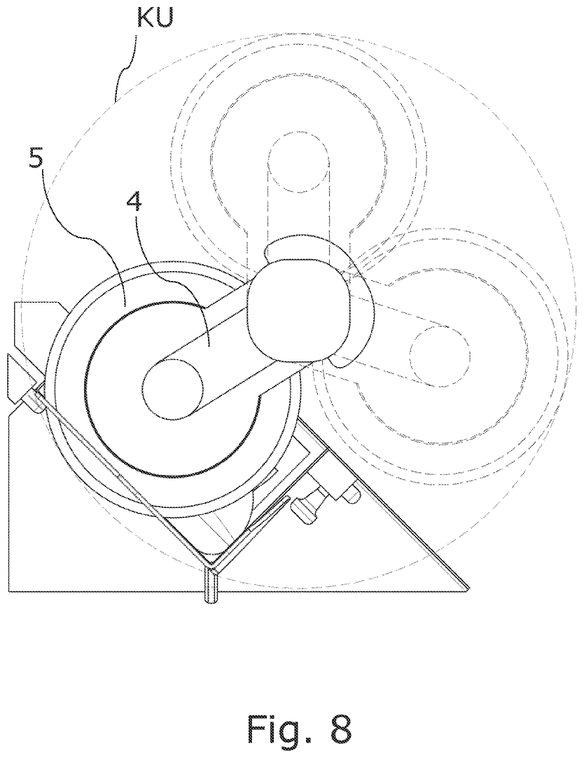

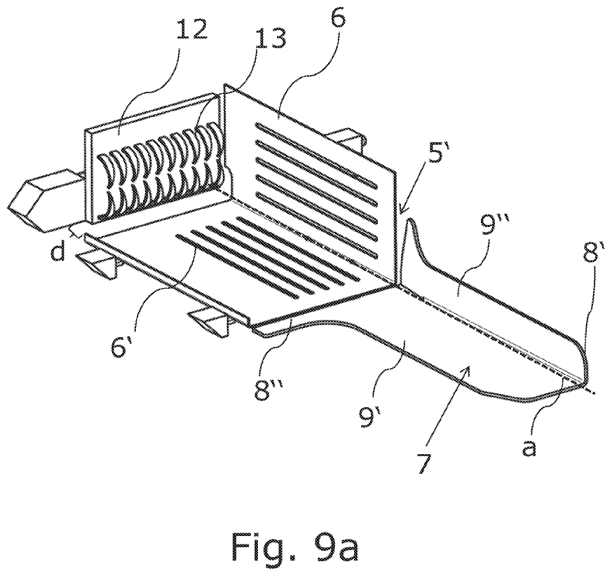

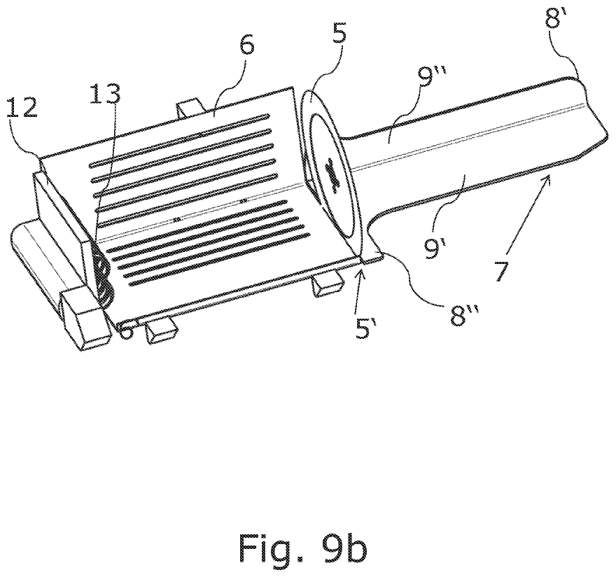

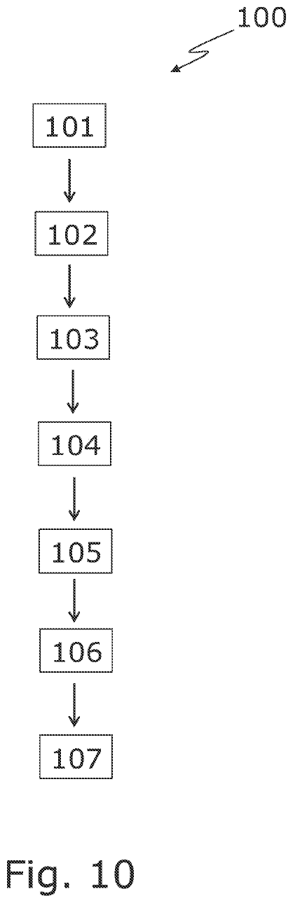

FIG. 1 is a section through a bread slicer according to an aspect of the invention, with the cover open. FIGS. 2 to 5b show method steps of the slicing process, with the cover closed. FIG. 6 is a three-dimensional view of a feed chute, a receiving chute, a slicing blade, and a crumb compartment of the bread slicer. FIG. 7 is a sectional view looking at the bread slicer from above (i.e., without the cover). FIG. 8 shows a possible movement path of the slicing blade. FIGS. 9a and 9b are three-dimensional views of the feed chute and receiving chute, without and with the slicing blade moved into place. FIG. 10 is a flowchart for schematically illustrating the bread slicing method according to an aspect of the invention.

The bread slicer 1 shown in FIG. 1 has a slicer housing 2. In said slicer housing there is a drive motor 3 for driving a slicing blade 5, which is retained on a blade arm 4 (see FIG. 8) and rotates in a slicing plane E. The blade arm 4 is driven by a drive motor 3′ for the blade arm 4. A bearing block 3″ retains the blade arm 4.

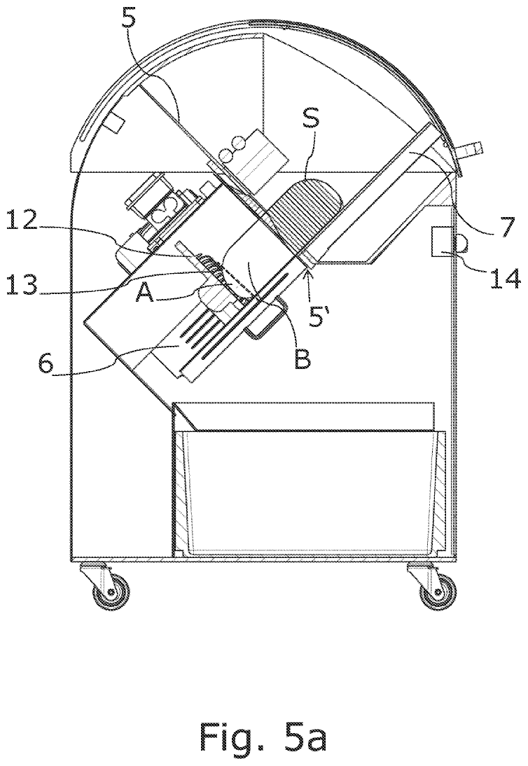

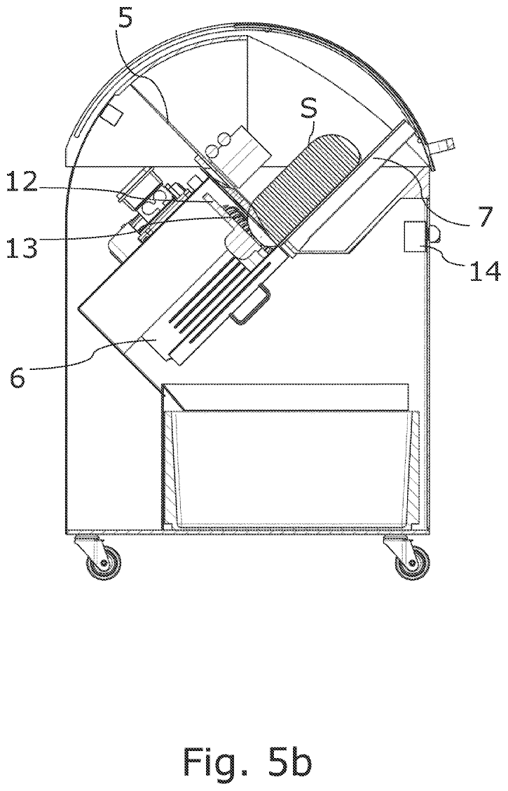

The bread slicer 1 furthermore has a feed chute 6 for introducing a loaf of bread B (see FIG. 2) to be sliced into the bread slicer 1 through a loading region EB. A receiving chute 7 for receiving all the slices S (see FIG. 5b) of the sliced loaf adjoins the feed chute 6 except for a blade gap 5′. The receiving chute 7 is formed as a bagging aid having a cantilevered portion 8. The receiving chute 7 is also arranged inside a cover 2′ of the slicer housing 2.

The receiving chute 7 is formed by two sheet metal portions 9′, 9″ that adjoin each other at an angle and together are L-shaped in cross section (cf. FIGS. 9a and 9b). A connecting axis a between the feed chute 6 and the receiving chute 7 is arranged in a manner inclined with respect to the vertical, preferably by approximately 45°. Through-slots 6′ are arranged in the feed chute 6 for breadcrumbs to fall through. A crumb compartment 10 is arranged below the through-slots 6′ in the feed chute 6, and in particular one or more deflector sheets 11 are located above said crumb compartment. Generally, four such deflector sheets 11 project into the crumb compartment from above in a funnel-like manner.

An advancing plate 12 having a gripper 13 for holding the loaf B can travel from one end of the feed chute 6 remote from the receiving chute 7 as far as over the blade gap 5′ and back again. The loaf B introduced into the feed chute 6 can rest on the advancing plate 12 by its end face.

An electronic control device 14 is configured to cause the unsliced loaf B to be transported from the receiving chute 7 into the feed chute 6 past the slicing blade 5, which has been retracted out of the blade gap 5′, and then to cause the loaf B that is to be sliced to be transported back from the feed chute 6 into the receiving chute 7, the slicing blade 5 being inserted into and retracted out of the blade gap 5′ during the return transportation in such a way that the loaf B is cut into parallel slices S in the process (see FIGS. 5a and 5b).

The cover 2′ of the slicer housing 2 is movable in a rotational motion on a guide rail 15 in order to open and close the slicer housing 2. A sensor 16 is used to switch off the bread slicer 1, in particular the slicing blade 5, in an emergency.

The initially unsliced loaf B is loaded into the receiving chute 7, as can be seen in FIG. 2.

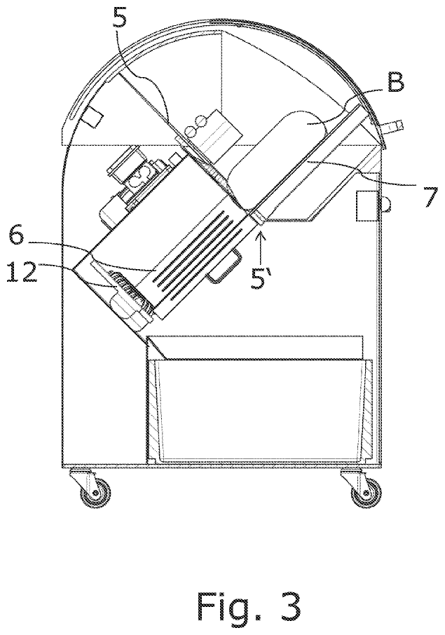

Next, the as-yet-unsliced loaf B slides against the slicing blade 5 in the blade gap 5′; see FIG. 3. Alternatively, the slicing blade 5 can be retracted out of the blade gap 5′ and the advancing plate 12 can be moved over the blade gap 5′ into the receiving chute 7, in which case the loaf B slides against the advancing plate 12. The advancing plate 12 covers the blade gap 5′ and protects users of the bread slicer 1 from the slicing blade 5, in particular when the cover 2′ of the bread slicer is still open.

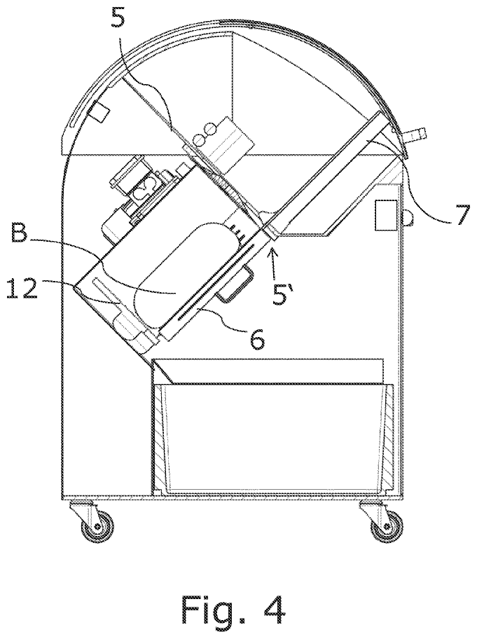

The advancing plate 12 having the gripper 13 is moved, with the claws of the gripper 13 retracted, toward the slicing blade 5, in particular over the blade gap 5′, the slicing blade 5 being retracted out of the blade gap 5′ in the process. The loaf B slides against the gripper 13. The advancing plate 12 is moved, with the claws of the gripper 13 retracted, together with the loaf B which is resting by its end face on the advancing plate 12, from a starting position in the receiving chute 7 into an intermediate position at the end of the feed chute 6 remote from the receiving chute 7; see FIG. 4.

The slicing blade 5 is then moved into the blade gap 5′. The advancing plate 12 having the loaf B resting thereon is moved toward the slicing blade 5 into a striking position until the loaf B rests on the slicing blade 5. The advancing plate 12 and the slicing blade 5 secure the loaf B. Next, the claws of the gripper 13 are inserted into a securing portion A (indicated by a dashed line) of the loaf B in order to secure the loaf during the slicing process. In this case, the claws of the gripper 13 can be formed to be relatively small, as a result of which the end piece of the sliced bread can then be kept particularly thin later on.

The still-unsliced loaf B is conveyed into the receiving chute 7 over the blade gap 5′ in multiple stages. In the process, the electronic control device 14 causes the slicing blade 5 to move into the blade gap 5′ multiple times automatically during the step-by-step transportation in order to cut off one slice S from the loaf B each time. The slicing blade 5 is then moved fully out of the blade gap 5′ again each time in order to allow each slice S to be transported onward into the receiving chute 7 and to allow the rest of the loaf B that is still unsliced at this time to be transported onward over the blade gap 5′; see FIG. 5a.

Lastly, the loaf, which has been sliced except for an end piece, in particular the securing portion A, is located back in the receiving chute 7, which is formed as the bagging aid having the cantilevered portion 8, and can be conveniently and safely removed therefrom; see FIG. 5b. In particular, the slicing blade 5 is retracted out of the blade gap 5′. The advancing plate 12 is moved over the blade gap 5′ into the receiving chute 7 and covers the blade gap 5′. As a result, users of the bread slicer 1 cannot accidentally reach into the blade gap 5′ and injure themselves on the sharp slicing blade 5. The claws of the gripper 13 are moved out of the loaf B.

The deflector sheet 11 is arranged on the crumb compartment 10 obliquely to the horizontal so as to deflect crumbs into the crumb compartment 10; see FIG. 6.

FIG. 7 shows in particular the drive motor 3 for the slicing blade 5, the drive motor 3′ for the blade arm 4, and the bearing block 3″ that retains the blade arm 4. The slicing blade 5 can be inserted into the blade gap 5′ from the side.

In this case, the blade arm 4 is configured to move the slicing blade 5 on a curve KU, preferably a circular curve.

In the process, the rotating slicing blade 5 is periodically inserted into and retracted back out of the blade gap 5′ in order to cut off the slices S, in particular in a constant circular motion induced by the drive motor 3′ for the blade arm 4; see FIG. 8.

The L profile of the receiving chute 7, which is formed by the two sheet metal portions 9′, 9″ that adjoin each other at an angle, is shown in detail in FIGS. 9a and 9b. In this context, in FIG. 9b the slicing blade 5 is inserted into the blade gap 5′. The advancing plate 12 can travel so far that a spacing d is formed between the advancing plate 12 and the feed chute 6; see FIG. 9a.

FIG. 10 is a flowchart for schematically illustrating the bread slicing method 100 according to an aspect of the invention:

In a first step 101, the loaf B is loaded into the receiving chute 7. In the process, the loaf B can in particular slide down in the feed chute 6 directly against the advancing plate 12. Alternatively, the loaded loaf B can also first be caught in the receiving chute 7 by the slicing blade 5, if the slicing blade has been inserted into the blade gap 5′, and only slide down into the feed chute 6 once the slicing blade 5 has retracted out of the blade gap 5′. Another option is for the slicing blade 5 to be located outside of the blade gap 5′ when the loaf B is loaded. In that case, instead of the slicing blade 5, the advancing plate 12 is lifted into the lower region of the receiving chute 7 up to the blade gap 5′ or further beyond it, and covers the blade gap 5′ against undesirable contact from the outside so as to prevent any risk of injury. In this position, the advancing plate 12 gently catches the loaded loaf B and then travels back to its starting position at the bottom of the feed chute 6 together with the loaf B.

In a second step 102, the advancing plate 12 is moved, with the claws of the gripper 13 retracted, together with the loaf B which is resting by its end face on the advancing plate 12, from its starting position in the receiving chute 7 into an intermediate position at the end of the feed chute 6 that is remote from the receiving chute 7.

In a third step 103, the slicing blade 5 is moved into the blade gap 5′.

In a fourth step 104, the advancing plate 12 is moved out of the intermediate position into a striking position, in which the loaf B touches the slicing blade 5 and presses, by its second end face remote from the advancing plate 12, against the slicing blade 5, which has been inserted into the blade gap 5′.

In a fifth step 105, the claws of the gripper 13 are extended and inserted into the loaf B, which is secured in the striking position.

In a sixth step 106, the still-unsliced loaf B is fully transported into the receiving chute 7 over the blade gap 5′ in multiple stages, the electronic control device 14 causing the slicing blade 5 to move into the blade gap 5′ multiple times automatically during the step-by-step transportation in order to cut off one slice S from the loaf B each time, and the slicing blade 5 then moving fully out of the blade gap 5′ again each time in order to allow each slice S to be transported onward into the receiving chute 7 and to allow the rest of the loaf B that is still unsliced at this time to be transported onward over the blade gap 5′. This operating situation is illustrated in FIGS. 5a and 5b.

In a seventh step 107, the claws of the gripper 13 are lastly retracted out of the end piece of the otherwise sliced loaf.

Afterwards, the slices S, together with the unsliced rest of the loaf B, can be removed from the receiving chute 7.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SIGNS

| | |
|---|---|
| 1 | Bread slicer |
| 2 | Slicer housing |
| 2′ | Cover |
| 3 | Drive motor for the slicing blade |
| 3′ | Drive motor for the blade arm |
| 3″ | Bearing block for the blade motor |
| 4 | Blade arm |
| 5 | Slicing blade |
| 5′ | Blade gap |
| 6 | Feed chute |
| 6′ | Through-slots |
| 7 | Receiving chute |
| 8 | Cantilevered portion |
| 8′ | Free end of the cantilevered portion |
| 8″ | Receiving-chute end facing the feed chute |
| 9′, 9″ | Sheet metal portions |
| 10 | Crumb compartment |
| 11 | Deflector sheets |
| 12 | Advancing plate |
| 13 | Gripper |
| 14 | Electronic control device |
| 15 | Guide rail |
| 16 | Sensor |
| 100 | Bread slicing method |
| 101 | First step of the bread slicing method |
| 102 | Second step of the bread slicing method |
| 103 | Third step of the bread slicing method |
| 104 | Fourth step of the bread slicing method |
| 105 | Fifth step of the bread slicing method |
| 106 | Sixth step of the bread slicing method |
| 107 | Seventh step of the bread slicing method |
| a | Connecting axis between the feed chute and the receiving chute |
| B | Loaf of bread |
| d | Spacing from the gripper to the feed chute |
| E | Slicing plane |
| S | Slices |
| KU | Curve |

1. A bread slicer for cutting a loaf of bread into slices, the bread slicer comprising:
a slicer housing, the slicer housing accommodating a drive motor and a slicing blade, the slicing blade being configured to be driven by the drive motor, the slicing blade being retained on a blade arm, and the slicing blade being configured to rotate in a slicing plane or to be movable in a circulating manner;
a feed chute configured to introduce the loaf to be sliced into the bread slicer;
a receiving chute, which adjoins the feed chute except for a blade gap, the receiving chute being configured for receiving all of the slices of the sliced loaf; and
an advancing plate, the advancing plate being configured such that an end face of the loaf introduced into the feed chute rests thereon and comprising a gripper provided with claws for holding the loaf,
wherein a connecting axis between the feed chute and the receiving chute is arranged in a manner inclined with respect to a vertical by at least 30°,
wherein the receiving chute is arranged above the feed chute in a vertical direction,
wherein the advancing plate is configured such that it is able to travel from one end of the feed chute remote from the receiving chute as far as over the blade gap and back again,
wherein the bread slicer further comprises an electronic controller, which is configured to:
cause the claws of the gripper to extend out and reach into an end-face securing portion, which is elongated in the direction of the connecting axis, of the loaf introduced into the feed chute,
then to cause the as-yet-unsliced loaf to be transported into the receiving chute over the blade gap, and
to cause the slicing blade to travel into the blade gap multiple times automatically during the transportation in order to cut off one slice from the loaf each time, and the slicing blade then moving fully back out of the blade gap again in order to allow each cut-off slice to be transported onward into the receiving chute and to allow the rest of the as-yet-unsliced loaf to be transported onward over the blade gap.

2. The bread slicer according to claim 1, wherein the receiving chute is formed by two sheet metal portions that adjoin each other at an angle and together are L-shaped in cross section.

3. The bread slicer according to claim 1, wherein a cover of the slicer housing is movable in a rotational motion on a guide rail.

4. The bread slicer according to claim 3, wherein the slicing blade, when in a non-activated state outside of the blade gap, is arranged in the bread slicer so as to be impossible to touch from outside of the cover of the slicer housing.

5. The bread slicer according to claim 3, wherein the receiving chute is arranged such that, before the slicing process, an unsliced loaf can be placed by a user onto a cantilevered portion, formed as a bagging aid, of the receiving chute, and wherein, after the slicing process, the slices of the sliced loaf are removable from the cantilevered portion by the user, after having pulled a bag-like packaging thereover.

6. The bread slicer according to claim 3, wherein the bread slicer has a shorter side and a longer side, a cantilevered portion and an input device for the electronic control device being accessible to a user from the shorter side of the bread slicer.

7. The bread slicer according to claim 1, wherein through-slots are arranged in the feed chute for breadcrumbs to fall through.

8. The bread slicer according to claim 1, wherein a spacing is formed between the advancing plate, in its state maximally retracted away from the receiving chute, and the feed chute.

9. The bread slicer according to claim 7, wherein a crumb compartment, having a deflector sheet, is arranged below the advancing plate or the feed chute.

10. The bread slicer according to claim 1, wherein the extendable claws of the gripper are geometrically configured in terms of shape and extent such that the length of an end-face securing portion of the loaf that has been introduced into the feed chute and is resting on its end face is at most twice a thickness of the slices to be cut off later, or is the same thickness as the slices.

11. The bread slicer according to claim 1, wherein an engagement height of the claws of the gripper, which corresponds to a length of an end-face securing portion in a direction of a connecting axis, is between 10 mm and 40 mm or from 20 mm to 30 mm.

12. The bread slicer according to claim 1, the bread slicer comprising a detection apparatus, which, in an operating state in which the loaf introduced into the feed chute is moved by means of the advancing plate toward the slicing blade, which has been inserted into the blade gap, is configured to detect when the loaf strikes the slicing blade, the detection apparatus comprising a pressure sensor, or a photoelectric sensor, or a current sensor configured to measure a current electrical current through an electrical drive that moves the advancing plate, or a resistance measurer configured to measure a current electrical resistance between the advancing plate and the slicing blade.

13. The bread slicer according to claim 12, wherein the electronic control device is configured to cause the claws of the gripper to extend out of the advancing plate and reach into the securing portion of the as-yet-unsliced loaf in the feed chute only when the detection apparatus detects that the loaf has struck the slicing blade.

14. A bread slicing method for cutting off the slices from the loaf of bread using the bread slicer according to claim 1, the method comprising:
a) loading the loaf into the receiving chute;
b) moving the advancing plate, with the claws of the gripper retracted, together with the loaf which is resting by its end face on the advancing plate, from a starting position in the receiving chute into an intermediate position at the end of the feed chute remote from the receiving chute;
c) moving the slicing blade into the blade gap;
d) moving the advancing plate out of the intermediate position into a striking position in which the loaf touches the slicing blade;
e) extending the claws of the gripper and inserting them into the loaf, which is secured in the striking position;
f) fully transporting the as-yet-unsliced loaf into the receiving chute over the blade gap in multiple stages, the electronic control device causing the slicing blade to move into the blade gap multiple times automatically during the step-by-step transportation in order to cut off one slice from the loaf each time, and the slicing blade then moving fully out of the blade gap again each time in order to allow each slice to be transported onward into the receiving chute and to allow the rest of the loaf EB that is still unsliced at this time to be transported onward over the blade gap;
g) retracting the claws of the gripper out of the end piece of the otherwise sliced loaf.

15. The method according to claim 14, wherein step e) is carried out only when a detection apparatus has detected that the loaf has struck the slicing blade while step d) is being carried out, and has reported this to the electronic control device.
